(19) United States
(12) Patent Application Publication
(10) Pub. No.: US 2013/0329594 A1
(43) Pub. Date: Dec. 12, 2013

(54) METHODS, APPARATUSES, AND SYSTEMS FOR FLEXIBLE RANK ADAPTATION IN A WIRELESS COMMUNICATION NETWORK

(71) Applicants: Alexei Vladimirovich Davydov, Nizhny Novgorod (RU); Gregory Vladimirovich Morozov, Nizhny Novgorod (RU); Hooman Shirani-Mehr, Portland, OR (US); Alexander Alexandrovich Maltsev, Nizhny Novgorod (RU); Vadim Sergeyevich Sergeyev, Nizhny Novgorod (RU); Ilya Alexandrovich Bolotin, Nizhny Novgorod (RU)

(72) Inventors: Alexei Vladimirovich Davydov, Nizhny Novgorod (RU); Gregory Vladimirovich Morozov, Nizhny Novgorod (RU); Hooman Shirani-Mehr, Portland, OR (US); Alexander Alexandrovich Maltsev, Nizhny Novgorod (RU); Vadim Sergeyevich Sergeyev, Nizhny Novgorod (RU); Ilya Alexandrovich Bolotin, Nizhny Novgorod (RU)

(21) Appl. No.: 13/994,031

(22) PCT Filed: Sep. 30, 2011
(86) PCT No.: PCT/RU11/00748

§ 371 Date: Aug. 27, 2013

Related U.S. Application Data
(60) Provisional application No. 61/471,042, filed on Apr. 1, 2011.

(51) Int. Cl. H04W 24/02; H04B 7/04

(52) U.S. Cl. CPC H04W 24/02; H04B 7/0456
USPC 370/252

(57) ABSTRACT

In various embodiments, a first base station may communicate with a first user equipment (UE) over a wireless communication channel. The first base station may receive an interference indication from a second base station communicating with a second UE on the same wireless communication channel. In response to the interference indication, the first base station may transmit a request to the first UE for the first UE to send feedback information associated with the wireless communication channel to the first base station for one or more transmission ranks specified by the first base station. The first UE may determine the requested feedback information and transmit the determined feedback information to the first base station. Thereafter, the first base station may reduce a transmission rank of ongoing transmissions to the UE based on the interference indication and the determined feedback information.

### CROSS REFERENCE TO RELATED APPLICATION

The present application claims priority to U.S. Patent Application No. 61/471,042, titled “Advanced Wireless Communication Systems And Techniques,” filed Apr. 1, 2011, the entire specification of which is hereby incorporated by reference in its entirety for all purposes.

### TECHNICAL FIELD

Embodiments of the present disclosure relate generally to wireless communication systems, and more particularly, to methods and apparatuses for flexible rank adaptation in wireless communication networks.

### BACKGROUND

Wireless communication networks may include one or more user equipments (UEs) that receive multiple input multiple output (MIMO) transmissions from one or more base stations (e.g., evolved NodeBs). The MIMO transmissions will have a transmission rank equal to the number of data streams in the transmission (e.g., a MIMO transmission with a transmission rank of three will have three data streams). In a process referred to as rank adaptation, a UE may unilaterally select a transmission rank and feedback the selected transmission rank to a base station, which may use the transmission rank for communications with the UE. The UE may also send a channel quality indicator (Cal) and a precoding matrix index (PMI) for the UE-selected transmission rank.

### BRIEF DESCRIPTION OF THE DRAWINGS

Embodiments of the present disclosure will be described by way of exemplary embodiments, but not limitations, illustrated in the accompanying drawings in which like references denote similar elements, and in which:

FIG. 1A schematically illustrates a wireless communication network in accordance with various embodiments.

FIG. 1B schematically illustrates a wireless communication network in accordance with various embodiments.

FIG. 1C schematically illustrates a wireless communication network in accordance with various embodiments.

FIG. 2 illustrates an information flow scheme in accordance with various embodiments.

FIG. 3 schematically illustrates a user equipment (UE) in accordance with various embodiments.

FIG. 4 schematically illustrates a base station in accordance with various embodiments.

### DETAILED DESCRIPTION

Illustrative embodiments of the present disclosure include, but are not limited to, methods and apparatuses for flexible rank adaptation in a wireless communication network.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having,” and “including” are synonymous, unless the context dictates otherwise. The phrase “A and/or B” means (A), (B), or (A and B). The phrase “A/B” means (A), (B), or (A and B), similar to the phrase “A and/or B”. The phrase “at least one of A, B and C” means (A), (B), (C), (A and B), (A and C), (B and C) or (A, B and C). The phrase “(A) B” means (B) or (A and B), that is, A is optional.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Embodiments of the present disclosure may be used in wireless communication networks that employ orthogonal frequency division multiple access (OFDMA) communications as used by multicarrier transmission schemes presented in, e.g., the Institute of Electrical and Electronics Engineers (IEEE) 802.16-2009, approved May 13, 2009, along with any amendments, updates, and/or revisions (e.g., 802.16m, which is presently at predraft stage), 3rd Generation Partnership Project (3GPP) long-term evolution (LTE) project, advanced LTE project, ultra mobile broadband (UMB) project (also referred to as “3GPP2”), etc. In other embodiments, communications may be compatible with additional/alternative communication standards and/or specifications.

In various embodiments, the wireless communication network may be Internet Protocol (IP) based. For example, a UE may exchange authentication information with, and receive an IP address from, the IP-based wireless communication network for communicating with IP packets via the network. The UE may be in a connected state after receiving the IP address.

Some embodiments of the present disclosure include a user equipment (UE) including a receiver module configured to wirelessly receive a request from a base station to provide feedback information associated with a wireless communication channel between the UE and the base station for one or more transmission ranks specified by the base station; a channel estimation module coupled with the receiver module and configured to determine, based on the request, feedback information associated with the wireless communication channel for each of the one or more transmission ranks; and a transmitter module coupled with the channel estimation module and configured to transmit the determined feedback information to the base station.

In some embodiments of the UE, the determined feedback information includes a channel quality indicator (CQI) and a precoding matrix index (PMI) for the wireless communication channel for each of the one or more transmission ranks specified by the base station.

In some embodiments of the UE, the determined feedback information includes one or more indicators and the transmitter module is further configured to time-division multiplex the one or more indicators with at least one indicator for a UE-selected transmission rank, unilaterally selected by the UE, to form a multiplexed signal, and to transmit the multiplexed signal to the base station via an uplink control channel.

In some embodiments of the UE, the receiver module is configured to receive the request from the base station via radio resource control (RRC) signaling.

In some embodiments, the UE further includes a plurality of antennas coupled to the receiver module, the receiver module is configured to receive, within a wireless communication session, transmissions from the base station with a transmission rank of two or greater, and the receiver module is further configured to receive, within the wireless communication session and subsequent to the transmission of the determined feedback information to the base station by the transmitter module, a transmission from the base station with another transmission rank that is less than the transmission rank.

In some embodiments of the UE, the transmission with the other transmission rank has properties based at least in part on the determined feedback information for the other transmission rank.

In some embodiments of the UE, the one or more transmission ranks are specified by the base station as a range of transmission ranks up to a transmission rank unilaterally selected by the UE.

Some embodiments of the present disclosure include a base station including a transmitter module configured to transmit to a user equipment (UE) a request for the UE to provide indicator feedback associated with a wireless communication channel between the UE and the base station for one or more transmission ranks specified by the base station, and a receiver module configured to receive from the UE the indicator feedback associated with the wireless communication channel for the one or more transmission ranks specified by the base station.

In some embodiments, the base station is a first base station and the receiver module is further configured to receive, from a second base station, a request to reduce a transmission rank for transmissions between the first base station and the UE, and the transmitter module is further configured to transmit a transmission of reduced transmission rank in response to the request from the second base station, the transmission of the reduced transmission rank having properties based at least in part on the indicator feedback received from the UE.

In some embodiments of the base station, the requested indicator feedback includes a channel quality indicator (CQI) and a precoding matrix index (PMI) for the wireless communication channel for each of the one or more transmission ranks specified by the base station.

In some embodiments of the base station, the receiver module is further configured to receive from the UE a multiplexed signal including the requested indicator feedback time-division multiplexed with indicator feedback associated with the wireless communication channel for a transmission rank unilaterally selected by the UE.

In some embodiments of the base station, the base station is a first base station and the receiver module is further configured to receive, from a second base station, a request to reduce transmissions from the first base station on the wireless communication channel, and wherein the transmitter module is further configured to stop transmissions to the UE on the wireless communication channel in response to the request, and to start transmissions to another UE on the wireless communication channel, the transmissions to the other UE having a lower rank than the transmissions to the UE.

In some embodiments, the base station further includes a processor coupled to the transmitter module and configured to determine the one or more transmission ranks for which the base station requests indicator feedback from the UE.

In some embodiments, the base station is an evolved nodeB.

In some embodiments, the transmitter module is further configured to send the received indicator feedback to a central processor communicatively coupled with a plurality of base stations including the base station, and the receiver module is further configured to receive a transmission rank indicator from the central processor to specify a transmission rank for the base station to use when communicating with the UE on the wireless communication channel and/or a UE identifier from the central processor to specify the UE for the base station to communicate with on the wireless communication channel.

In some embodiments, a method of the present disclosure includes receiving, by a first base station associated with a first cell, an interference indication from a second base station associated with a second cell; receiving, by the first base station, feedback information for a plurality of transmission ranks associated with transmissions of a wireless communication session on a wireless communication channel in the first cell; and reducing, by the first base station, a transmission rank of the transmissions of the wireless communication session on the wireless communication channel based at least in part on the interference indication and the feedback information.

In some embodiments of the method, the plurality of transmission ranks includes one or more transmission ranks specified by the first base station, and the method further comprising transmitting, by the first base station to the UE, a request for the UE to provide the feedback information for the one or more transmission ranks specified by the first base station.

In some embodiments of the method, the plurality of transmission ranks further includes a transmission rank unilaterally selected by the UE, and wherein the requested feedback information is received with the feedback information for the transmission rank unilaterally selected by the UE as a time-division multiplexed communication.

In some embodiments of the method, the request is transmitted to the UE via radio resource control (RRC) signaling.

In some embodiments of the method, the feedback information includes a channel quality indicator (CQI) and/or a precoding matrix index (PMI) for the wireless communication channel for each of the plurality of transmission ranks.

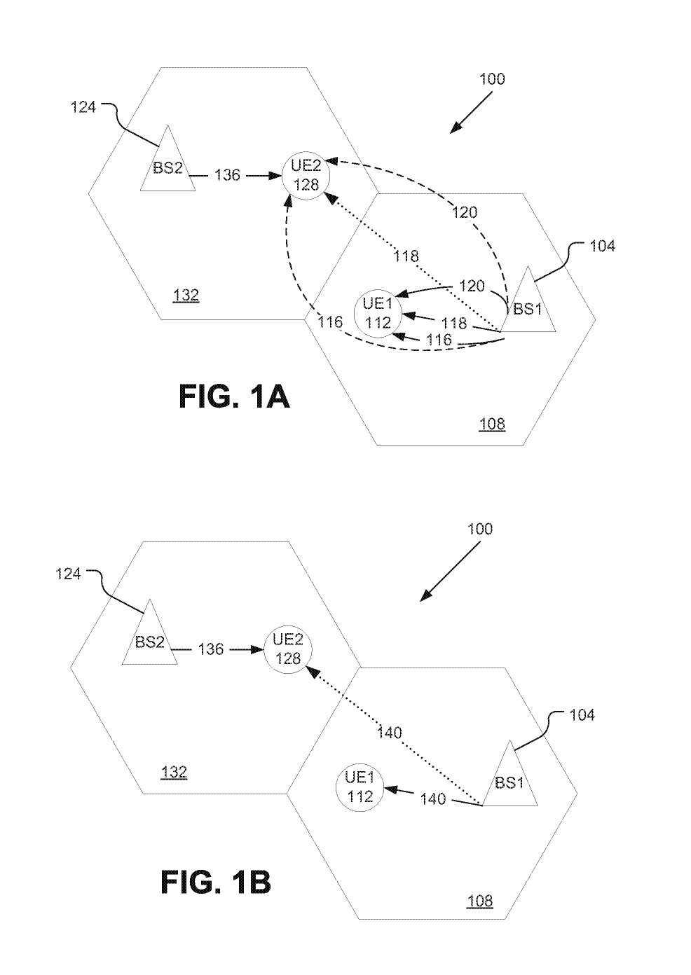

FIG. 1A schematically illustrates a wireless communication network 100, in accordance with various embodiments. The wireless communication network 100 may include a first base station (BS1 104) that may communicate with one or more user equipments (UEs) within a cell 108. A first UE 112 (UE1 112) in cell 108 may communicate with BS1 104 over a wireless communication channel during a wireless communication session. In various embodiments, BS1 104 and UE1 112 may be multiple input multiple output (MIMO) devices. Accordingly. BS1 104 may include a plurality of antennas to allow BS1 to send transmissions to UE1 112 having a transmission rank of two or greater. Similarly, UE1 112 may include a plurality of antennas to allow UE1 to receive transmissions from BS1 104 having a transmission rank of two or greater. As shown in FIG. 1A, BS1 104 is transmitting to UE1 112, within a wireless communication session, a transmission with a transmission rank of three, including first data stream 116, second data stream 118, and third data stream 120. In other embodiments, BS1 104 may transmit to UE1 112 with any suitable transmission rank.

In various embodiments, UE1 112 may be any device capable of wirelessly communicating with one or more base stations over a wireless communication channel using any appropriate wireless transmission protocol. The UE 112 may be, for example, a mobile station, a cellular or mobile phone, a personal computer (PC), a tablet computer, an e-reader, a personal digital assistant (FDA), a pager, and/or another consumer electronics device such as an mp3 player.

BS1 104 may be any appropriate type of evolved NodeB and/or any other appropriate type of base station configured to wirelessly communicate with one or more UEs over a wireless communication channel using any appropriate wireless transmission protocol.

In various embodiments, UE1 112 may transmit feedback information associated with the wireless communication channel to BS1 104. The feedback information may include a transmission rank unilaterally selected by UE1 112 (i.e., a UE-preferred rank) for transmissions from BS1 104 to UE1 112 on the wireless communication channel. The feedback information may also include one or more indicators associated with the wireless communication channel for the UE-preferred transmission rank, such as a channel quality indicator (CQI), a precoding matrix index (PMI), and/or one or more modulation and coding schemes (MCSs). UE1 112 may transmit the feedback information to BS1 104 via an uplink control channel.

In various embodiments, the wireless communication network 100 may further include a second base station 124 (BS2 124) communicating over the wireless communication channel with a second UE 128 (UE2 128) in a second cell 132. UE2 128 may receive a fourth data stream 136 from BS2 124. However, UE2 128 may also receive data streams 116, 118 and/or 120 as interference (as illustrated by the dashed lines in FIG. 1A). UE2 128 may cancel the interference using multiple antenna techniques. However, UE2 128 may require one antenna to receive its intended data stream (e.g., fourth data stream 136), and one antenna for each interfering data stream to successfully cancel each interfering data stream. As shown in FIG. 1A, assuming UE2 128 includes only two antennas, UE2 128 will only be able to cancel one interfering data stream (e.g., data stream 118, as shown in FIG. 1A by the dotted line representing the portion of data stream 118 received and cancelled by UE2 128). UE2 128 will not be able to cancel the other two interfering data streams (e.g., data streams 116 and 120). Accordingly, BS2 124 may transmit a request to BS1 104 for BS1 104 to reduce the transmission rank of its transmissions on the wireless communication channel

The term “wireless communication channel,” as used herein, refers to a logical connection over a multiplexed wireless medium. In an OFDM-based transmission protocol, the wireless communication channel may be divided into a plurality of sub-carriers in frequency and into a plurality of OFDM symbols in time, which may be organized as resource blocks of M subcarriers by N OFDM symbols. In some embodiments transmission of signals between a base station and one or more UEs may use at least one resource block, although the scope of the invention is not limited in this respect.

In various embodiments, the one or more UEs and base stations of the wireless communication network may communicate with one another over the wireless communication channel using one or more different or related techniques, such as coordinated multipoint (CoMP), cooperative scheduling, MIMO, Multi-base station MIMO, and the like. In various embodiments, the UEs may be interference-aware receivers.

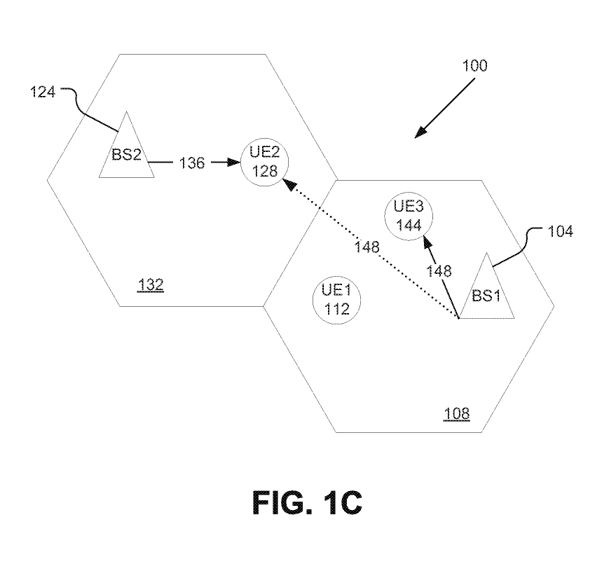

FIG. 2 illustrates an information flow scheme 200 in accordance with various embodiments. In various embodiments, BS1 104 may send a request, at 204, to UE1 112 to provide feedback information associated with the wireless communication channel for one or more transmission ranks specified by BS1 104. BS1 104 may send the request at 204 in response to the request by BS2 124 for BS1 104 to reduce the transmission rank of its transmissions on the wireless communication channel. The one or more transmission ranks may be specified as a set of ranks (e.g., ranks 1, 2, 3, and 4, and/or ranks 2, 3, and 5), or as a range of one or more ranks up to the UE-preferred rank for UE1 112. In various embodiments, the one or more transmission ranks may be less than the UE-preferred rank. In some embodiments, the BS1 104 may send the request to UE1 112 via a radio resource control (RRC) signaling message in a higher layer base station control channel. In the physical layer, the RRC signaling message may be sent in the Physical Downlink Control Channel (PDCCH) and/or Physical Downlink Shared Channel (PDSCH).

In various embodiments, at 208, UE1 112 may receive the request from BS1 104 for feedback information related to the one or more transmission ranks specified by BS1 104. At 212, UE1 112 may determine the requested feedback information associated with the wireless communication channel for each of the one or more transmission ranks specified by BS1 104. UE1 112 may then transmit, at 216, the requested feedback information to BS1 104. The feedback information may also be referred to as indicator feedback, and may include one or more indicators, such as a CQI, PMI, and/or one or more MCSs for each of the one or more transmission ranks specified by BS1 104. In some embodiments, the feedback information may include an MCS for each spatial stream in a transmission for the corresponding transmission rank. Thus, for a transmission rank of three, the feedback information may include three MCS indicators, one MCS indicator for each of the three spatial streams in a rank three transmission.

In some embodiments, UE1 112 may time-division multiplex the requested feedback information with the feedback information for the UE-preferred rank to form a multiplexed signal. The multiplexed signal may be sent by UE1 112 to BS1 104 via the uplink control channel between UE1 112 and BS1 104. Accordingly, time-division multiplexing the requested feedback information with the feedback information for the UE-preferred rank may allow SS1 104 to receive the requested feedback information without using additional frame resources compared with transmitting the feedback information for only the UE-preferred transmission rank on the uplink control channel.

In various embodiments, BS1 104 may receive, at 220, the feedback information from the UE1 112 for the one or more transmission ranks specified by BS1 104. BS1 104 may then, at 224, reduce the transmission rank of subsequent transmissions to UE1 112 within the wireless communication session. Accordingly, the BS1 104 may send a subsequent transmission to UE1 112, within the wireless communication session, with a transmission rank that is reduced compared with a transmission rank of earlier transmissions within the wireless communication session. In some embodiments, the BS1 104 may reduce the transmission rank of transmissions to the UE1 112 in response to the request from BS2 124.

In some embodiments, BS1 104 may send the feedback information received from UE1 112 to a central processor. The central processor may be communicatively coupled with a plurality of base stations, including BS1 104 and BS2 124. In some embodiments, the central processor may be located on BS1 104, on another base station, and/or in another location. The central processor may receive feedback information from a plurality of base stations relating to channel conditions between the base stations and their respective associated UEs. For example, the central processor may receive feedback information from BS1 104 relating to channel conditions between BS1 104 and UE1 112, and may receive feedback information from BS2 124 relating to channel conditions between BS2 124 and UE2 128. The feedback information may include one or more feedback indicators associated with one or more transmission ranks. In some embodiments, the central processor may determine one or more transmission ranks for which feedback information is needed from the UE and instruct the base station to request the feedback information from its associated UE for the determined transmission ranks.

The central processor may determine, based on the feedback information from the plurality of base stations, a transmission rank for each base station (e.g., BS1 104) to use when communicating with its associated UE (i.e., UE1 112) on the channel. The transmission rank for each base station may be determined to maximize overall throughput among the plurality of base stations. The central processor may send the transmission rank determined for each base station to the respective base station. For example, the central processor may send the transmission rank determined for BS1 104 to BS1 104. BS1 104 may then send transmissions to its associated UE (e.g., UE1 112) with the determined transmission rank received from the central processor.

In some embodiments, the central processor may additionally, or alternatively, determine the UE for each base station to communicate with on the channel. The central processor may send a UE identifier to each base station to specify the UE with which the base station will communicate. The base station may then send transmissions to the UE associated with the UE identifier.

FIG. 1B illustrates the wireless network 100 with BS1 104 sending a transmission of reduced transmission rank to UE1 112. As shown in FIG. 1B, BS1 104 is sending a transmission having a transmission rank of one (including data stream 140). UE2 128 is able to successfully decouple data stream 140 from UE2's intended data stream 136, and cancel data stream 140. In other embodiments, the transmission of reduced transmission rank may have a transmission rank of two or greater, depending on the reduced rank requested by BS2 124.

The transmissions of reduced transmission rank may have properties based at least in part on the feedback information requested, and received, from UE1 112 by BS1 104 for the corresponding transmission rank. For example, BS1 104 may apply precoding or beamforming to the transmissions based on the PMI received from UE1 112 for the corresponding transmission rank.

In some embodiments, as shown in FIG. 1C, BS1 104 may, in response to the request from BS2 124, stop transmissions to UE1 112 on the wireless communication channel and start transmissions (e.g., data stream 148) to a third UE 144 (UE3 144) on the wireless communication channel. UE3 144 may have a UE-preferred transmission rank that is less than the UE-preferred transmission rank of UE1 112. BS1 104 may transfer UE1 112 to another wireless communication channel and/or another base station that is capable of transmitting to UE1 112 with its UE-preferred transmission rank. Accordingly, switching communications on the wireless communication channel to a UE having a lesser UE-preferred rank may increase the overall system throughput.

Although individual cells are illustrated to be approximately hexagonal in shape and similar in size, in various other embodiments, the cells may be of any shape and/or size, and/or may overlap. In other embodiments, BS1 104 and BS2 124 may be associated with the same cell. Additionally, in some embodiments. UE1 112 and UE2 128 may communicate with the same base station over the wireless communication channel, particularly if UE1 112 and UE2 128 are located in substantially different directions from the base station so that precoding (using the PMI received from the UE) may be used to direct the transmissions to the intended UE without causing substantial interference to other UEs in the cell on the same wireless communication channel.

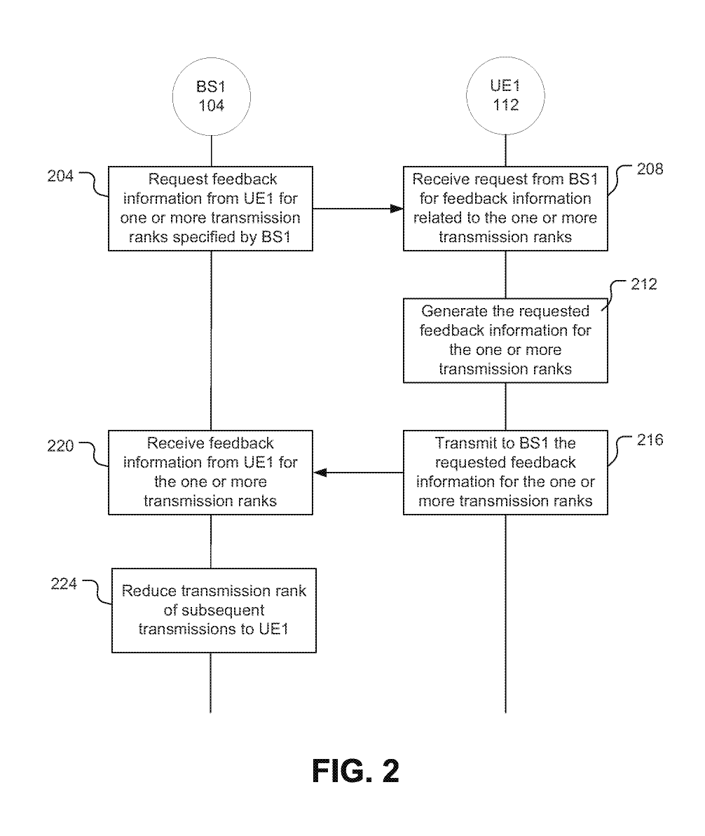

FIG. 3 schematically illustrates a UE 300, in accordance with various embodiments. The UE 300 may communicate with one or more base stations over a wireless communication channel during one or more wireless communication sessions. In various embodiments, UE 300 may be equivalent to UE1 112 as depicted in FIGS. 1 and 2, and discussed above. In various embodiments, the UE 300 may include one or more antennas, e.g., antennas 310a-d, configured to receive signals transmitted from one or more base stations (e.g., BS1 104 in FIGS. 1A-C and 2). In FIG. 3, four antennas are illustrated, although in various other embodiments, any other suitable number of antennas may be included in the UE 300. In various embodiments, the UE 300 may include at least as many antennas as a number of one or more data streams being transmitted by the base station to the UE 300, although the scope of the present disclosure may not be limited in this respect. One or more of the antennas 310a-d may be alternately used as transmit or receive antennas. Alternatively, or additionally, one or more of the antennas 310a-d may be dedicated receive antennas or dedicated transmit antennas.

In various embodiments, UE 300 may include a receiver module 320 configured to wirelessly receive transmissions from a base station (e.g., BS1 104) over a wireless communication channel via one or more of the antennas 310a-d. The receiver module 320 may receive a request from the base station to provide feedback information associated with the wireless communication channel to the base station relating to one or more transmission ranks specified by the base station. In some embodiments, the request may be received from the base station via RRC signaling.

In various embodiments, the UE 300 may further include a channel estimation module 330 coupled with the receiver module 320. The channel estimation module 330 may determine, based on the request from the base station, feedback information associated with the wireless communication channel for each of the one or more transmission ranks specified by the base station. In some embodiments, the determined feedback information may include one or more indicators, such as a CQI, a PMI, and/or one or more MCSs associated with the wireless communication channel for each of the one or more transmission ranks.

In some embodiments, the channel estimation module may also determine feedback information associated with the wireless communication channel for a transmission rank unilaterally selected by the UE 300 (i.e., a UE-preferred transmission rank). In some embodiments, the request from the base station may specify a set of one or more transmission ranks (e.g., 1, 2, 3, 4), or a range of one or more transmission ranks up to the UE-preferred transmission rank.

In various embodiments, the UE 300 may further include a transmitter module 340 coupled with the channel estimation module 330 and configured to transmit messages to the base station via one or more of the antennas 310a-d. In various embodiments, the transmitter module 340 may transmit the requested feedback information to the base station. In some embodiments, the transmitter module 340 may time-division multiplex the one or more indicators of the requested feedback information with at least one indicator of the feedback information for the UE-preferred rank to form a multiplexed signal. The transmitter module 340 may transmit the multiplexed signal to the base station. In some embodiments, the requested feedback information may be transmitted via an uplink control channel.

In various embodiments, subsequent to the transmitter module 340 transmitting the requested feedback information to the base station, the receiver module 320 may receive one or more transmissions of reduced rank (i.e., transmissions having a transmission rank that is less than a transmission rank of earlier transmissions within the same wireless communication session).

FIG. 3 is a high-level functional block diagram of UE 300, and in other embodiments, additional components may be coupled to and/or between the antennas 310a-d, receiver module 320, channel estimation module 330, and/or transmitter module 340. For example, in some embodiments, one or more of the components of UE 300 may be coupled to a processor. The processor may perform one or more of the functions attributed to other components above, and/or other functions.

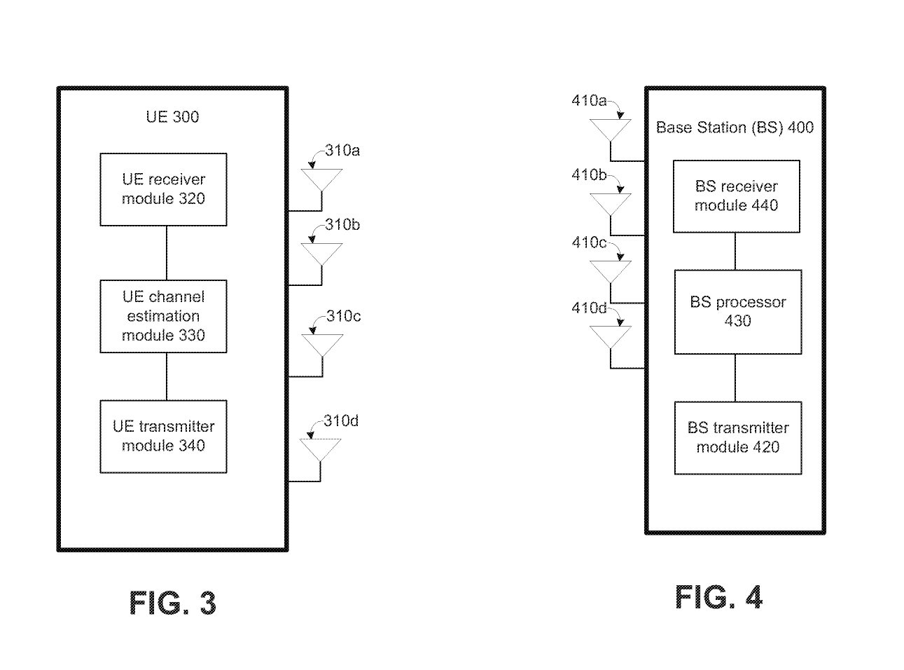

FIG. 4 schematically illustrates a base station 400, in accordance with various embodiments. Base station 400 may be configured to communicate with one or more UEs over a wireless communication channel during one or more wireless communication sessions. In various embodiments, base station 400 may be equivalent to BSI 104 depicted in FIGS. 1A-C and 2, and discussed above. In various embodiments, the base station 400 may be an eNodeB. Base station 400 may include a plurality of antennas 410a-d configured to transmit signals to, and/or receive signals from, one or more UEs (e.g., UE1 112 in FIGS. 1A-C and 2 and/or UE 300 in FIG. 3). In FIG. 4, four antennas are illustrated, although in various other embodiments, any other suitable number of antennas may be included in the base station 400. Having a plurality of antennas may allow the base station 400 to send transmissions having a transmission rank of two or greater (i.e., including two or more data streams). In various embodiments, the base station 400 may include at least as many antennas as a number of one or more data streams being transmitted by the base station, although the scope of the present disclosure may not be limited in this respect. One or more of the antennas 410a-d may be alternately used as transmit or receive antennas. Alternatively, or additionally, one or more of the antennas 410a-d may be dedicated transmit antennas or dedicated receive antennas.

Base station 400 may further include a transmitter module 420 configured to transmit signals to the one or more UEs over a wireless communication channel. In various embodiments, the transmit module 420 may transmit a request to a first UE (e.g., UE 300) for the first UE to provide indicator feedback associated with the wireless communication channel between the first UE and the base station 400 for one or more transmission ranks specified by the base station. In some embodiments, the base station 400 may include a processor 430, coupled to the transmitter module, to select the one or more transmission ranks for which to request indicator feedback from the first UE. In some embodiments, the transmitter module 420 may send the request to the first UE via RRC signaling.

In various embodiments, the base station 400 may further include a receiver module 440 configured to receive signals from the first UE over the wireless communication channel. Receiver module 440 may be coupled to transmitter module 430 via processor 430. In various embodiments, the receiver module 440 may receive the requested indicator feedback from the first UE. The requested indicator feedback may include one or more indicators, such as a CQI, a PMI, and/or one or more MCSs associated with the wireless communication channel for each of the one or more transmission ranks specified by the base station 400. In some embodiments, the receiver module may receive a multiplexed signal from the first UE, the multiplexed signal including the requested indicator feedback time-division multiplexed with indicator feedback associated with the wireless communication channel for a transmission rank unilaterally selected by the first UE (e.g., a UE-preferred transmission rank),

In various embodiments, the receiver module 440 may also be configured to receive signals from a second base station. In some embodiments, the receiver module 440 may include a first receiver configured to receive signals from one or more UEs, as described above, and a second receiver configured to receive signals from one or more other base stations (e.g., the second base station). hi some embodiments, the second receiver may receive signals from the second base station over a wired communication link. In other embodiments, the second receiver may receive signals from the second base station over a wireless communication link.

In various embodiments, the receiver module 440 may receive an interference indication from the second base station, including a request from the second base station for the base station 400 to reduce the transmission rank of transmissions by base station 400 on the wireless communication channel. This may occur, for example, if the second base station is communicating with a second UE on the wireless communication channel, and the second UE is receiving the transmissions from base station 400 as interference and is unable to suppress the interfering transmissions.

In response to the interference indication, the base station 400 may send a request to the first UE, via the transmitter module 420, for the indicator feedback, as described above. After receiving the requested indicator feedback from the first UE, the transmitter module 420 may reduce a transmission rank of ongoing transmissions from the transmitter module 420 to the first UE in response to the interference indication from the second base station. Thereafter, the transmitter module 420 may transmit one or more transmissions of reduced transmission rank (i.e., transmissions having a transmission rank that is less than a transmission rank of earlier transmissions within the same wireless communication session). The transmission of reduced transmission rank may have properties based at least in part on the requested indicator feedback received from the first UE by receiver module 440. For example, the transmitter module 420 may apply precoding or beamforming to the transmission of reduced transmission rank based on the PMI for the corresponding transmission rank.

In some embodiments, the receiver module 440 may receive a message from the second base station indicating that base station 400 may resume transmissions to the first UE with the first UE's preferred transmission rank. This may occur, for example, if the second base station is no longer communicating with the second UE on the wireless communication channel.

In some embodiments, transmitter module 420 may stop transmissions to the first UE on the wireless communication channel in response to the interference indication from the second base station. In these embodiments, transmitter module 420 may instead transmit to another UE on the wireless communication channel. The transmissions to the other UE may have a lower transmission rank than the transmission rank of the earlier transmissions to the first UE. In some embodiments, the transmitter module 420 may send transmissions to the first UE on a different wireless communication channel.

Although certain example methods, apparatus, and articles of manufacture have been described herein, the scope of coverage of the present disclosure is not limited thereto. On the contrary, the present disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

1. An apparatus to be employed by a user equipment (UE), the apparatus comprising:
a receiver module configured to wirelessly receive a request from a base station to provide feedback information associated with a wireless communication channel between the UE and the base station for one or more transmission ranks specified by the base station;
a channel estimation module coupled with the receiver module and configured to determine, based on the request, feedback information associated with the wireless communication channel for each of the one or more transmission ranks; and
a transmitter module coupled with the channel estimation module and configured to transmit the determined feedback information to the base station.

2. The apparatus of claim 1, wherein the determined feedback information includes a channel quality indicator (CQI) and a precoding matrix index (PMI) for the wireless communication channel for each of the one or more transmission ranks specified by the base station.

3. The apparatus of claim 1, wherein the determined feedback information includes one or more indicators and the transmitter module is further configured to time-division multiplex the one or more indicators with at least one indicator for a UE-selected transmission rank, unilaterally selected by the UE, to form a multiplexed signal, and to transmit the multiplexed signal to the base station via an uplink control channel.

4. The apparatus of claim 1, wherein the receiver module is configured to receive the request from the base station via radio resource control (RRC) signaling.

5. The apparatus of claim 1, further comprising a plurality of antennas coupled to the receiver module, wherein the receiver module is configured to receive, within a wireless communication session, transmissions from the base station with a transmission rank of two or greater, and wherein the receiver module is further configured to receive, within the wireless communication session and subsequent to the transmission of the determined feedback information to the base station by the transmitter module, a transmission from the base station with another transmission rank that is less than the transmission rank.

6. The apparatus of claim 5, wherein the transmission with the other transmission rank has properties based at least in part on the determined feedback information for the other transmission rank.

7. The apparatus of claim 1, wherein the one or more transmission ranks are specified by the base station as a range of transmission ranks up to a transmission rank unilaterally selected by the UE.

8. An apparatus to be employed by a base station, the apparatus comprising:
a transmitter module configured to transmit to a user equipment (UE) a request for the UE to provide indicator feedback associated with a wireless communication channel between the UE and the base station for one or more transmission ranks specified by the base station; and
a receiver module configured to receive from the UE the indicator feedback associated with the wireless communication channel for the one or more transmission ranks specified by the base station.

9. The apparatus of claim 8, wherein the base station is a first base station and the receiver module is further configured to receive, from a second base station, a request to reduce a transmission rank for transmissions between the first base station and the UE, and the transmitter module is further configured to transmit a transmission of reduced transmission rank in response to the request from the second base station, the transmission of the reduced transmission rank having properties based at least in part on the indicator feedback received from the UE.

10. The apparatus of claim 8, wherein the requested indicator feedback includes a channel quality indicator (CQI) and a precoding matrix index (PMI) for the wireless communication channel for each of the one or more transmission ranks specified by the base station.

11. The apparatus of claim 8, wherein the receiver module is further configured to receive from the UE a multiplexed signal including the requested indicator feedback time-division multiplexed with indicator feedback associated with the wireless communication channel for a transmission rank unilaterally selected by the UE.

12. The apparatus of claim 8, wherein the base station is a first base station and the receiver module is further configured to receive, from a second base station, a request to reduce transmissions from the first base station on the wireless communication channel, and wherein the transmitter module is further configured to stop transmissions to the UE on the wireless communication channel in response to the request, and to start transmissions to another UE on the wireless communication channel, the transmissions to the other UE having a lower rank than the transmissions to the UE.

13. The apparatus of claim 8, further comprising:
a processor coupled to the transmitter module and configured to determine the one or more transmission ranks for which the base station requests indicator feedback from the UE.

14. The apparatus of claim 8, wherein the base station is an evolved nodeB.

15. The apparatus of claim 8, wherein the transmitter module is further configured to send the received indicator feedback to a central processor communicatively coupled with a plurality of base stations including the base station, and the receiver module is further configured to receive a transmission rank indicator from the central processor to specify a transmission rank for the base station to use when communicating with the UE on the wireless communication channel and/or a UE identifier from the central processor to specify the UE for the base station to communicate with on the wireless communication channel.

16. A method comprising:
receiving, by a first base station associated with a first cell, an interference indication from a second base station associated with a second cell;
receiving, by the first base station, feedback information for a plurality of transmission ranks associated with transmissions of a wireless communication session on a wireless communication channel in the first cell; and
reducing, by the first base station, a transmission rank of the transmissions of the wireless communication session on the wireless communication channel based at least in part on the interference indication and the feedback information.

17. The method of claim 16, wherein the plurality of transmission ranks includes one or more transmission ranks specified by the first base station, and the method further comprising transmitting, by the first base station to the UE, a request for the UE to provide the feedback information for the one or more transmission ranks specified by the first base station.

18. The method of claim 17, wherein the plurality of transmission ranks further includes a transmission rank unilaterally selected by the UE, and wherein the requested feedback information is received with the feedback information for the transmission rank unilaterally selected by the UE as a time-division multiplexed communication.

19. The method of claim 17, wherein the request is transmitted to the UE via radio resource control (RRC) signaling.

20. The method of claim 16 wherein the feedback information includes a channel quality indicator (CQI) and/or a precoding matrix index (PMI) for the wireless communication channel for each of the plurality of transmission ranks.
